(19) United States
(12) Patent Application Publication
(10) Pub. No.: US 2019/0323591 A1
(43) Pub. Date: Oct. 24, 2019

(54) TOOTHED WHEEL

(71) Applicant: Miba Sinter Austria GmbH, Laakirchen (AT)

(72) Inventors: Franz-Josef GIELESBERGER, Ohlsdorf (AT); Karl DICKINGER, Vorchdorf (AT); Dominik KRONBERGER, Vorchdorf (AT)

(73) Assignee: Miba Sinter Austria GmbH, Laakirchen (AT)

(21) Appl. No.: 16/371,336

(22) Filed: Apr. 1, 2019

(30) Foreign Application Priority Data
Apr. 24, 2018 (AT) A 50342/2018

(51) Int. Cl. F16H 55/17

(52) U.S. Cl. CPC F16H 55/17

(57) ABSTRACT

A toothed wheel includes a hub part, a web part radially adjoining it and a toothed crown carried by the web part, wherein several kidney-shaped openings separated from one another by webs are formed in the web part. The kidney-shaped openings are disposed in several rows formed radially one above the other.

### CROSS REFERENCE TO RELATED APPLICATIONS

Applicant claims priority under 35 U.S.C. § 119 of Austrian Application No. A 50342/2018 filed Apr. 24, 2018, the disclosure of which is incorporated by reference.

### BACKGROUND OF THE INVENTION

### 1. Field of the Invention

The invention relates to a toothed wheel comprising a hub part, a web part radially adjoining it and a toothed crown carried by the web part, wherein several kidney-shaped openings separated from one another by webs are formed in the web part.

### 2. Description of the Related Art

From the prior art, toothed wheels are already known that are produced in lightweight construction for reduction of mass-related motion-energy losses. For this purpose, it is possible on the one hand to use appropriately lightweight materials. On the other hand, the toothed wheels may be configured structurally with recesses, so that a weight reduction is achieved. Such an embodiment variant having kidney-shaped recesses is known, for example, from DE 11 2011 103 094 T5.

Besides the weight reduction, the reduction of sound emissions also plays a role for toothed wheels. The most diverse approaches for this purpose are also already known from the prior art.

### SUMMARY OF THE INVENTION

The task underlying the present invention is to provide a toothed gear having reduced weight and improved noise behavior.

The task of the invention is accomplished for the toothed wheel mentioned in the introduction by the fact that the kidney-shaped openings are disposed in several rows formed radially one above the other.

It is of advantage in this connection that not only the mass itself of the toothed wheel may be reduced by the arrangement of further openings in radially different planes, but also an improvement of the noise behavior may be achieved therewith. The latter may be attributed to the fact that the sound has only smaller wall thicknesses available for propagation. These smaller wall thicknesses (in comparison to openings arranged in one row) may also be used to ensure that energy, and therefore also sound energy, can be dissipated in the form of vibrational energy due to the remaining mass in the web part or that the sound frequency can be influenced therewith, wherewith a further improvement of the noise behavior of the toothed wheel may be achieved during operation.

According to one embodiment variant of the toothed wheel, it may be provided that the webs formed between the openings are disposed in at least two rows in a manner offset in circumferential direction. Due to the avoidance of spoke-like webs that extend continuously over the entire radial height of the web part, a sound deflection may be achieved, whereby a further improvement of the noise behavior of the toothed wheel may be achieved. Beyond this, the statics of the toothed wheel may be improved therewith, so that, despite the small material proportion in the web part, it may be exposed to a relatively high load.

It may also be provided according to a further embodiment variant of the toothed wheel that at least individuals of the webs have a radial extent between the openings, wherewith a better load transfer is permitted during operation of the toothed wheel. Therewith a more rigid construction of the toothed wheel is possible.

On the other hand, however, it may be provided according to another embodiment variant of the toothed wheel that at least individuals of the webs between the openings have an extent deviating from radial direction, whereby, by virtue of the compliance of these webs under loading, a toothed wheel with softer engagement characteristic and thus changed noise behavior may be created.

According to one embodiment variant of the toothed wheel, it may be provided that the webs have a width in circumferential direction that is selected from a range of 3% to 30% of a maximum diameter of the toothed wheel. Therewith the foregoing effects may be further improved.

Another possibility for influencing of the weight and of the noise behavior of the toothed wheel may therefore be achieved by the fact that one radial height of the kidney-shaped openings is different.

In this connection, it may preferably be provided that the kidney-shaped openings have the same radial height within one row, wherewith the mechanical properties of the toothed wheel may be standardized more simply over the entire circumference.

For improvement of the noise behavior, however, it may also be provided that the radial height of the openings becomes larger from inside to outside in radial direction.

### BRIEF DESCRIPTION OF THE DRAWINGS

For better understanding of the invention, it will be explained in more detail on the basis of the following figures.

Therein, respectively in simplified schematic diagrams,

FIG. 1 shows a first embodiment variant of a toothed wheel;

FIG. 2 shows a second embodiment variant of a toothed wheel;

FIG. 3 shows a third embodiment variant of a toothed wheel;

FIG. 4 shows a fourth embodiment variant of a toothed wheel;

FIG. 5 shows a fifth embodiment variant of a toothed wheel.

### DETAILED DESCRIPTION OF PREFERRED EMBODIMENTS

By way of introduction, it is pointed out that like parts in the differently described embodiments are denoted with like reference symbols or like structural-part designations, wherein the disclosures contained in the entire description can be carried over logically to like parts with like reference symbols or like structural-part designations. The position indications chosen in the description, such as top, bottom, side, etc., for example, are also relative to the figure being directly described as well as illustrated, and these position indications are to be logically carried over to the new position upon a position change.

FIGS. 1 to 5 show various embodiment variants of a toothed wheel 1. What is common to these toothed wheels 1 is that they each have a hub part 2 (which may also be called a hub portion), a web part 3 (which may also be called a web portion) and a toothed crown 4. The hub part 2 serves for arrangement of the toothed wheel 1 on a shaft or the like, for which purpose the hub part 2 may have an opening 5 in an axial direction 6.

The web part 3 is formed directly adjoining the hub part 2 in radial direction.

The web part 3 carries the toothed crown 4, for which purpose the latter may be formed directly adjoining the web part 3 in radial direction.

The toothed crown 4 has, not illustrated in more detail, a toothing with teeth. As an example, the toothing may be constructed as a straight toothing or helical toothing.

The web part 3 may be made thinner in the axial direction 6 than can the hub part 2 and/or the toothed crown 4.

In general, the web part 3 may extend in radial direction by between 5% and 25% over a height of the toothed wheel 1. In the preferred embodiment variants of the toothed wheel 1, the rest of the radial height is distributed among the toothed crown 5 and the hub part 2, wherein the opening 5 of the hub part may amount to between 5% and 40% of the radial height of the toothed wheel 1, and the toothed crown may amount to between 20% and 50% of the radial height of the toothed wheel 1. Obviously, the indicated relative height values add up to 100%.

The radial height of the toothed wheel 1 corresponds to the radius of the tip-circle diameter of the teeth of the toothing.

Preferably, the toothed wheel 1 is manufactured as a sintered structural part by a powder-metallurgical process. Since these processes are known in principle, further explanations of them are not needed. All that needs to be mentioned is that a powder-metallurgical process comprises the pressing of a metallic powder to a green compact, the sintering of the green compact and, if necessary, the post-processing of the sintered toothed wheel 1, such as by forming to size and/or hardening, for example.

The toothed wheel 1 is preferably made in one piece.

The web part 3 has several kidney-shaped openings 8 (cut-outs). The openings 8 are separated from one another in a circumferential direction 9 by webs 10.

It is now provided that not only are several openings 8 disposed next to one another in the circumferential direction 9, but also that several openings are formed next to one another in radial direction. The total number of kidney-shaped openings 8 is therefore distributed over several rows of openings 8 formed radially one above the other. The rows respectively extend in the circumferential direction 9 and therefore not linearly but instead at least approximately circularly or exactly circularly around the hub part 2.

A kidney-shaped opening 8 means an opening that has a larger dimension in the circumferential direction 9 than in the radial direction of the toothed gear 1. In addition, a kidney-shaped opening 8 is curved in the manner of an annular ring in the circumferential direction 9, but extends only over a segment of an annular ring, i.e. not over 360°. Two end regions 11, 12 situated opposite one another in the circumferential direction 9 are preferably likewise made in rounded manner, especially with semicircular cross section, viewed in the direction of the axial direction 6.

Preferably, exclusively such kidney-shaped openings 8 are formed in the web part 3 within one row or in the entire web part 3. However, the possibility also exists that differently shaped openings, for example circular openings (viewed in the direction of the axial direction 6) are also disposed or formed in addition to the kidney-shaped openings 8.

Between two, especially three and eight, especially between three and six openings 8 may be disposed or formed per row. Between two and six, especially between two and four rows may be disposed or formed one above the other in radial direction.

It is possible that a length of the openings 8 in the circumferential direction 9 amounts to between 15% and 25% of the circumference of the circle at half radial height of the respective opening 8 under consideration.

A radial height of the openings 8 may amount to between 5% and 40% of a maximum diameter of the toothed wheel 1. This maximum diameter is the diameter of the circle that the tooth tips of the teeth of the toothing just still touches, i.e. just envelops the toothed wheel 1. The diameter therefore corresponds to the tip-circle diameter of the teeth of the toothing.

In the embodiment variant of the toothed wheel 1 according to FIG. 1, the kidney-shaped openings 8 are disposed or formed on two rows formed one above the other in radial direction, wherein respectively four openings 8 may be formed per row. It must be pointed out, however, that the figures indeed illustrate embodiment variants of the toothed wheel 1, but these are not to be construed as limitative.

It is then possible that the webs 10 are formed or disposed in radiating or spoke-like manner between the kidney-shaped openings 8. This means that the webs 10 extend continuously from hub part 2 to the toothed crown 4.

Preferably, however, as is also illustrated in FIG. 1, the webs 10 of at least two rows are disposed or formed in a manner offset in the circumferential direction 9. In particular, the webs 10 of each row may be disposed or formed in a manner turned relative to the webs 10 respectively disposed under them by a value in the circumferential direction 9 that is selected from a range of 5° to 175°, especially from a range of 10° to 60°.

According to a preferred embodiment variant of the toothed wheel 1, the webs 10 of one row are offset by respectively 50% of a length 13 of an opening 8 in the circumferential direction 9 at half radial height 14 of the row of openings 8 formed directly underneath it. This embodiment variant is illustrated in FIGS. 1 to 5. In this connection, it may be provided, in the case of more than two rows of kidney-shaped openings 8, that the openings 8 of the radially outermost row are again disposed or formed in a manner turned or offset by this value in the circumferential direction. The webs 10 of the first and of the third row of kidney-shaped openings 8 may therefore be formed in alignment in radial direction.

Preferably, the openings 8 in this embodiment variant of the toothed wheel 1 have the same length 13 in circumferential direction 9 within the respective rows.

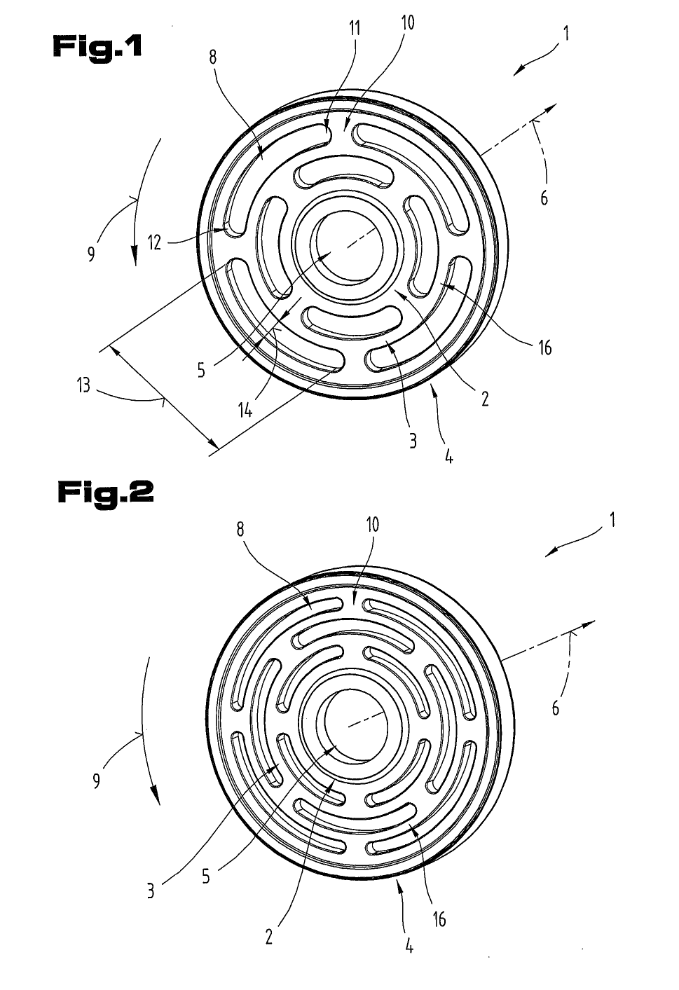

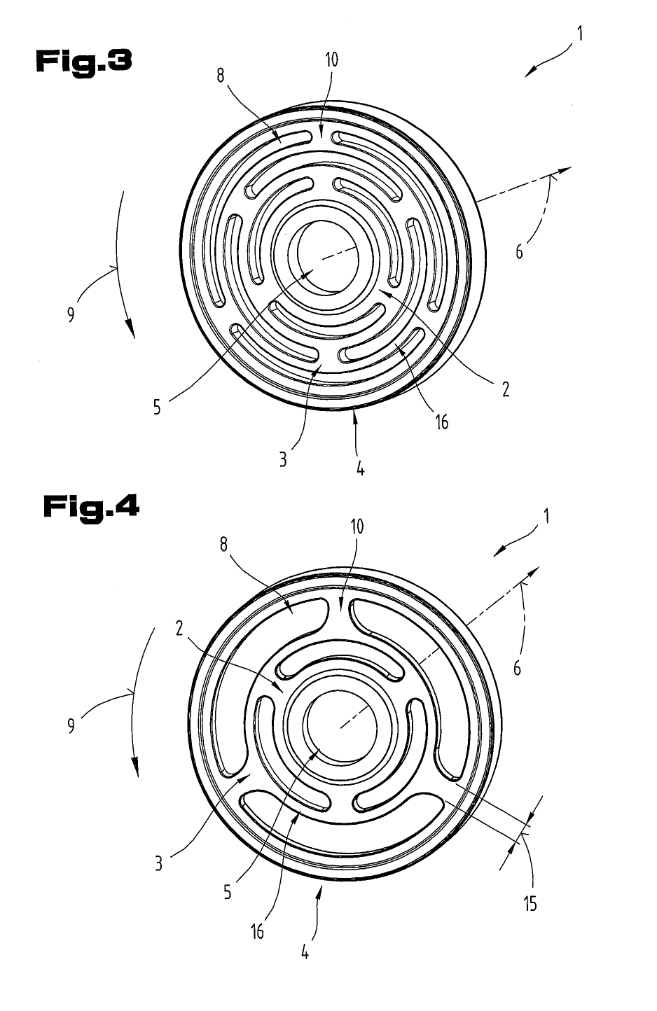

With the toothed wheels 1 illustrated in FIGS. 2 and 3, however, it is not merely intended to illustrate that more than two rows of kidney-shaped openings 8 may be disposed or formed. It is also possible to configure the length 13 of the openings 8 differently in the circumferential direction 9, so that, per row of kidney-shaped openings 8, three or four of these openings 8 may be disposed, wherein mixed variants are also possible, in which three and four kidney-shaped openings 8 are formed or disposed alternatingly.

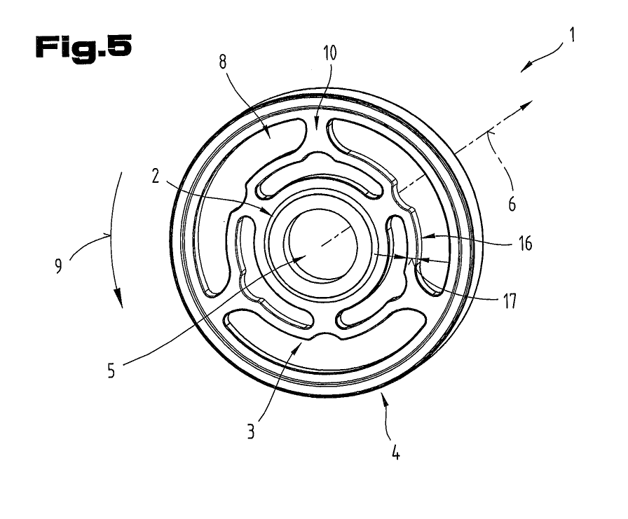

In principle, all webs 10 may be identically formed, especially may also have an identical width 15 (FIG. 4) in the circumferential direction 9. However, webs 10 with different widths 15 in the circumferential direction may also be disposed within a toothed wheel 1. For example, the webs 10 of various rows of kidney-shaped openings 8 may have a different width 15 in the circumferential direction 9, whereas the webs 10 within one row of kidney-shaped openings have the same width 15. Furthermore, the webs 10 themselves may have a different width 15 over their extent.

The different width 15 may relate not only to the width 15 in the direction of the axial direction 6. It is also possible for the webs 10 or at least one part of the webs 10 to have a different width in a direction perpendicular to the axial direction 6, and therefore, for example, viewed in axial section.

The webs 10 may have a radial extent, as is illustrated in FIGS. 1 to 5.

According to another embodiment variant of the toothed wheel 1, however, it is also possible that the webs 10 or at least individuals of the webs 10 have an extent deviating at least in regions or parts from the radial direction. For example, at least one part of the webs 10, especially all webs 10, may have a variably curved extent. For example, the webs 10 may have an S-shaped extent (as viewed in the axial direction 6).

According to another embodiment variant of the toothed wheel 1, it may be provided that the webs 10 have a width 15 in circumferential direction 9 that is selected from a range of 3% to 30% of the maximum diameter (tip-circle diameter) of the toothed wheel 1. In the axial direction 6, the webs 10 may have a width that is selected from a range of 10% to 100%, especially from a range of 55% to 75% of the maximum width of the toothed crown 4 in this direction.

It may also be provided, however, that the webs 10 have a width 15 in circumferential direction 9 that is selected from a range of 3% to 95% of the maximum diameter (tip-circle diameter) of the toothed wheel 1.

As is evident on the basis of the embodiment variant of the toothed wheel 1 according to FIG. 4, it may also be provided that the radial height 14 of the kidney-shaped openings 8 is different. Thus it is possible, for example, that—as illustrated—the radial height 14 of the kidney-shaped openings 8 becomes larger from inside to outside in radial direction. In this connection, however, it is still preferable for the radial height 14 of the kidney-shaped openings 8 to remain constant within one row of kidney-shaped openings 8.

It may also be provided, however, that the radial height 14 of the kidney-shaped openings 8 becomes larger from outside to inside.

Preferably, the toothed wheel 1 is symmetrically formed, at least in the web part 3.

By virtue of the kidney-shaped openings 8, the web part 3 has not only the webs 10 between the openings 8 within one row of openings 8, but also further webs 16 between the kidney-shaped openings 8 of two adjacent rows of kidney-shaped openings 8. These further webs 16 preferably have a length in the circumferential direction 9 that in terms of its numerical value is larger than a radial height 17 of the further webs 16 in radial direction.

According to one embodiment variant of the toothed wheel 1, it may be provided that the further webs 16 are equipped above the webs 10 and/or underneath the webs 10 with a concave rounding, as is illustrated in FIG. 5. In particular, this rounding may be circular. The resilience behavior of the further webs 16 may be influenced in this way.

According to another embodiment variant of the toothed wheel 1, the kidney-shaped openings 8 may be filled at least partly, especially entirely, with a material different from the material of the web part 3. In particular, a rubbery elastic material, preferably an elastomer, such as natural rubber or synthetic rubber, such as, for example, SB, (X)NBR, etc., may be disposed in these openings 8. Preferably, this further (different) material is bonded, for example vulcanized, with the material of the web part 3. In this way the noise emission of the toothed wheel 1 during operation may likewise be changed.

The exemplary embodiments show possible embodiment variants of the toothed wheel 1, wherein it must be noted at this place that diverse combinations of the individual embodiment variants with one another are also possible.

Finally, it must be pointed out, as a matter of form, that, for better understanding of the structure, elements of the toothed wheel 1 have not necessarily been illustrated to scale.

Although only a few embodiments of the present invention have been shown and described, it is to be understood that many changes and modifications may be made thereunto without departing from the spirit and scope of the invention.

### LIST OF REFERENCE SYMBOLS

1 Toothed wheel
2 Hub part
3 Web part
4 Toothed crown
5 Opening
6 Axial direction
7 Recess
8 Opening
9 Circumferential direction
10 Web
11 End region
12 End region
13 Length
14 Height
15 Width
16 Web
17 Height

What is claimed is:

1. A toothed wheel (1) comprising a hub part (2), a web part (3) radially adjoining it and a toothed crown (4) carried by the web part (3), wherein several kidney-shaped openings (8) through the web part (3) separated from one another by webs (10) are formed in the web part (3), wherein the kidney-shaped openings (8) are disposed in several rows formed radially one above the other.

2. The toothed wheel (1) according to claim 1, wherein the webs (10) formed between the kidney-shaped openings (10) are disposed in at least two rows in a manner offset from one another in circumferential direction (9).

3. The toothed wheel (1) according to claim 1, wherein at least some of the webs (10) have a radial extent between the kidney-shaped openings (8).

4. The toothed wheel (1) according to claim 1, wherein at least some of the webs (10) have an extent between the kidney-shaped openings (8) that deviates from the radial direction.

5. The toothed wheel (1) according to claim 1, wherein the webs (10) have a maximum width (15) in circumferential direction (9) that is selected from a range of 3% to 30% of a maximum diameter of the toothed wheel (1).

6. The toothed wheel (1) according to claim 1, wherein one radial height (14) of the kidney-shaped openings (8) is different.

7. The toothed wheel (1) according to claim 6, wherein the kidney-shaped openings (8) have the same radial height (14) within one row.

8. The toothed wheel (1) according to claim 6, wherein the radial height (14) of the kidney-shaped openings (8) becomes larger from inside to outside in radial direction.
